(19) United States
(12) Patent Application Publication
(10) Pub. No.: US 2023/0182024 A1
(43) Pub. Date: Jun. 15, 2023

(54) BEHAVIORAL ANALYSIS OF GAMING TRANSACTIONS

(71) Applicant: International Business Machines Corporation, Armonk, NY (US)

(72) Inventors: Aaron K. Baughman, Cary, NC (US); Gray Franklin Cannon, Atlanta, GA (US); Jeffrey Gottwald, Denver, CO (US); Shikhar Kwatra, San Jose, CA (US)

(21) Appl. No.: 17/457,979

(22) Filed: Dec. 7, 2021

(51) Int. Cl. A63F 13/792; G06Q 20/40; G06Q 20/12

(52) U.S. Cl. CPC A63F 13/792; G06Q 20/123; G06Q 20/4016

(57) ABSTRACT

A method, computer program product and computer system to determine suspicious activity by users via in-game transactions is provided. A processor identifies a transaction involving a player character operated by a user within a game. A processor retrieves player data associated with the player character and item data associated with the items offered during the transaction involving the player character. A processor determines an optimal choice for the player character based on a comparison between the player data and the item data during the transaction. A processor, in response to the user selecting a suboptimal choice different from the optimal choice, adjusts at least one behavioral score of a profile associated with the user. A processor, in response to the at least one behavioral score being outside an expected range of the at least one behavioral score, restricts at least one aspect of an account associated with the player character.

### BACKGROUND OF THE INVENTION

The present invention relates generally to the field of video games, and more particularly to monitoring user choice during transactions to determine suspicious activity by users.

In many video games, the acquisition of items through buying, selling, and trading is an essential feature of game play. Games are commonly designed to include items with varying degrees of rarity. Many users seek to acquire the rarest items, so these items have extremely high valuations with respect to in-game currency. The demand for rare items is so high that many online markets exist outside of games where users sell their in-game items for real-world currency or sell their game account in entirety. In these black markets, rare items are even stronger drivers of account value than high-level status. These real-world transactions are severe rules violations that can result in a permanent ban from the game.

### SUMMARY

Embodiments of the present invention provide a method, system, and program product to determine suspicious activity by users via in-game transactions. A processor identifies a transaction involving a player character operated by a user within a game. A processor retrieves player data associated with the player character and item data associated with the items offered during the transaction involving the player character. A processor determines an optimal choice for the player character based on a comparison between the player data and the item data during the transaction. A processor, in response to the user selecting a suboptimal choice different from the optimal choice, adjusts at least one behavioral score of a profile associated with the user. A processor, in response to the at least one behavioral score being outside an expected range of the at least one behavioral score, restricts at least one aspect of an account associated with the player character.

### BRIEF DESCRIPTION OF THE SEVERAL VIEWS OF THE DRAWINGS

FIG. 1 is a functional block diagram illustrating a gaming environment, in accordance with an exemplary embodiment of the present invention.

FIG. 2 illustrates operational processes of behavior module in a game coordinator program, on a computing device within the environment of FIG. 1, in accordance with an exemplary embodiment of the present invention.

FIG. 3 depicts an example scenario of player data and item data involved in a transaction, in accordance with an exemplary embodiment of the present invention.

FIG. 4 depicts a block diagram of components of the computing device executing game coordinator program, in accordance with an exemplary embodiment of the present invention.

### DETAILED DESCRIPTION

While solution to detecting fraudulent users in a video game is known, prior solutions typically rely on monitoring traffic from the user (e.g., IP address/geolocation) or locally run modules that detect cheats or other suspicious behavior. Embodiments of the present invention recognize that by monitoring a user’s choice during in game transactions a behavioral profile of the user can be generated. By building a behavioral profile that tracks a variety of types of user bias, embodiments of the present invention provide improvements to the detection of fraudulent users.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

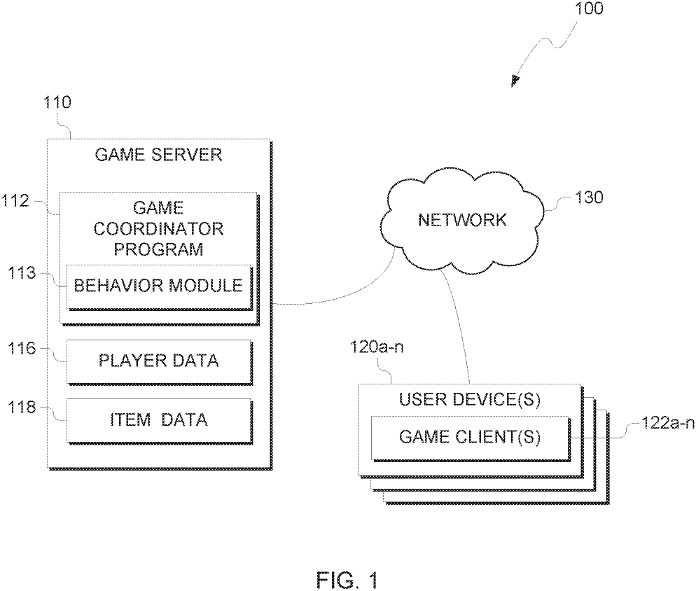

The present invention will now be described in detail with reference to the Figures. FIG. 1 is a functional block diagram illustrating game environment, generally designated 100, in accordance with one embodiment of the present invention. Game environment 100 includes game server 110 and user devices 120a-n connected over network 130. Game server 110 includes game coordinator program 112, behavior module 113, player data 116 and item data 118. User device(s) 120a-n include respective game client(s) 122a-n.

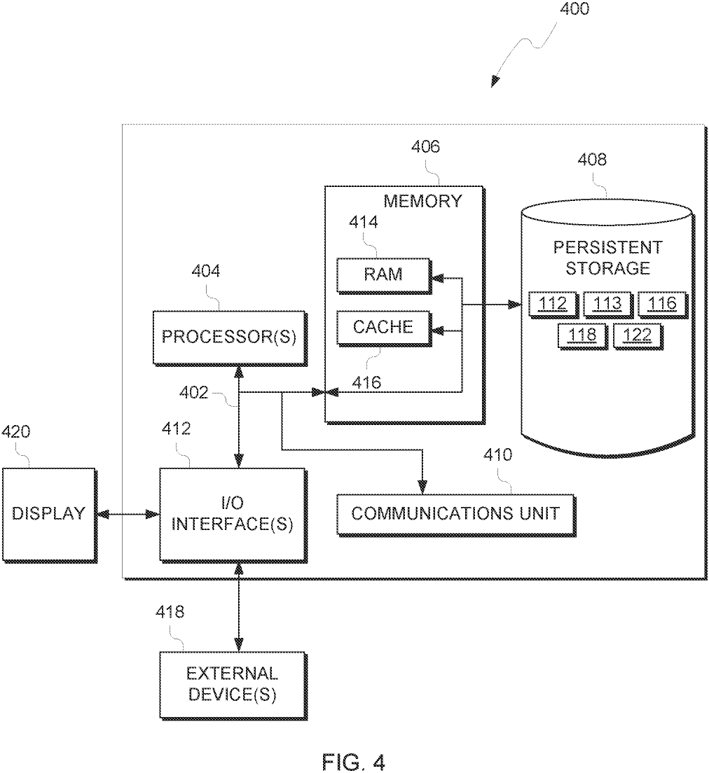

In various embodiments of the present invention, game server 110 and user devices 120a-n are each a computing device that can be a standalone device, a server, a laptop computer, a tablet computer, a netbook computer, a personal computer (PC), or a desktop computer. In another embodiment, game server 110 or each of user devices 120a-n each represents a computing system utilizing clustered computers and components to act as a single pool of seamless resources. In general, game server 110 or each user devices 120a-n can be any computing device or a combination of devices with access player data 116 and item data 118 and is capable of executing to game coordinator program 112, behavior module 113, and game clients 122a-n. Game server 110 and user devices 120a-n may include internal and external hardware components, as depicted and described in further detail with respect to FIG. 4.

In this exemplary embodiment, game coordinator program 112, behavior module 113, player data 116 and item data 118 are stored on game server 110. However, in other embodiments, game coordinator program 112, behavior module 113, player data 116 and item data 118 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network XXX can be any combination of connections and protocols that will support communications between game server 110 and user devices 120a-n, in accordance with a desired embodiment of the present invention.

In various embodiments, game coordinator program 112 maintains a game world or state that is shared, wholly or partially, among users (i.e., either via direct play such as a multiplayer game or other indirect mechanisms such as an auction house or marketplace). Each user has a game client 122 installed on the user device 120 that replicates the game world on the user device 120 as well as send any input provided by the user to game coordinator program 112. Game coordinator program 112 receives this information and updates the game world based on the received input from the user. In turn, game coordinator sends updates to other user’s game client(s) 122 a-n to update and change the game world displayed locally on each game client. Game coordinator program 112 maintains a variety of information and replicates the current state across each of the connected game clients 122a-n, such as player locations, action performed by users, items and abilities equipped by each user.

In various embodiments, game coordinator program 112 provides a game world that permits users to enter into transactions. A transaction is any exchange of in-game items, currency, or other resources within the game world. A transaction may be between two user-controlled characters or accounts. A transaction may also be between a user and a non-playable character, such as a virtual shopkeeper, or other game entity or destination, such as a marketplace or auction house. Additionally, in some scenarios, the transaction may occur outside of the game client. For example, an operator of game server 110 may have a website that permits transactions between users without interacting directly with game coordinator program 112. One of ordinary skill in the art will understand that a transaction as discussed herein can occur in a variety of methods (e.g., barter of goods or direct payment), participants (e.g., player characters and non-player character) and mediums (e.g., in-game or via an associated website) without deviating from this invention. As used herein, player character refers to any character or entity that is controlled by a user, via game client 122, and non-player character is any virtual character that is not directly controlled by a user but controlled by scripting or coding executed by game coordinator program 112.

In various embodiments, behavior module 113 monitors and reviews each transaction performed by users, such as in-game via game clients 122a-n. In some scenarios, behavior module 113 reviews transactions as they occur. In other scenarios, behavior module 113 reviews transactions at a later time. Furthermore, for transactions that occur outside of the game world (e.g., via a website operated by the owner of game server 110), behavior module 113 retrieves and reviews such transactions as well.

In various embodiments, behavior module 113 updates a behavioral profile associated with the user, or users, involved in a transaction within the game world or other related channel associated with the game. The behavioral profile maintains a score across multiple bias categories that reflect the motivation that a user is perceived to have when making the purchase involved in the transaction based on the user’s choice of item that was selected. For example, behavior module 113 maintains a “projection bias” category that is updated when a user makes a similar purchase repeatedly.

When reviewing transactions, behavior module 113 retrieves player data 116 associated with the user’s involved in a transaction as well as item data 118 of the items involved or offered during the transaction. Player data 116 includes a behavioral profile of the user as well as any in-game playable character values such as any statistics, values, buffs, effects, past transactions, and other any in-game value that the player character has during or proceeding the transaction. For example, in-game playable character values may include, but are not limited to, base stats or any other value associated with the user’s character (e.g., current health, maximum health, current mana pool, strength value, etc.), ongoing buff or de-buffs that are affecting the user, items equipped or owned by the player character, or any other in-game effect or item that alter the player character’s stats or values. Item data 118 includes, but is not limited to, the cost of the items offered in the transaction, a market value for the items offered, as well as the various stats, values and effects of each item has on the player character if equipped or otherwise used. Items, as discussed herein, can be any item, gear, boost, buff, debuff or other type of modifier that provides any permanent or temporary change to player data 116 when equipped or used.

In various embodiments, behavior module 113, when reviewing a transaction, compares the player data 116 of the user’s involved with the item data 118 of the items offered in a transaction. For example, a user, via game client 122, enters a transaction with a shopkeeper non-player character. As another example, a user, via game client 122 or an external website, enters a transaction with another user of the game. As used herein, transaction is any exchange of items between a user and a non-playable character or another user-controlled character for in-game currency or exchange of other items (i.e., barter)

In various embodiments, Behavior module 113 retrieves the player data 116 for the user as well as item data 118 of all items offered by the shopkeeper non-player character. Based on the current stats and other player data 116 (such as equipped items, applied buffs/debuffs, etc.), behavior module 113 compares the current player data 116 at the time of the transaction to each item offered to the player at the time of the transaction. In scenarios where the transaction has a limited number of offering, behavior module 113 compares each item offered during the transaction. In other scenarios, where a larger number of items may be offered, behavior module 113 identifies items the user viewed, inspected or otherwise observed during the transaction. For example, game coordinator program 112 monitors mouse movement or other user input to determine which items the user viewed, inspected or otherwise was aware of when making a choice during the transaction.

In various embodiments, behavior module 113 determines an optimal choice from the items offered or viewed during a transaction. For each value or stat in player data 116, behavior module 113 determines the benefit each offered or viewed item provides via the stats, buffs, and other player data 116 altering aspects of the items. Based the determined benefit, behavior module 113 adjust the cost of the item to reflect the increased or decreased value the item provides to the user, generating a circumstance adjusted value that reflects the specific value the player character would get from the item at the time of the transaction. For example, a user is at 80 out of 100 hit points. An offered health potion increases health by 10 at a cost of 10 gold. The circumstance adjusted value would increase the cost of 10 gold to by +10 to reflect the increased benefit of more hit points the potion would provide. As another example, if a user was at a 95 out of 100 hit points, then the circumstance adjusted value would be less at only +5 to reflect that only half of the potion is used.

In various embodiments, behavior module 113 determines an optimal choice among offered items in a transaction based on the circumstance adjusted value for each item, selecting the item with the highest circumstance adjusted value as being optimal. For the remaining sub-optimal items, behavior module 113 assigns a suboptimality score to the items. The suboptimality score is the difference between the largest circumstance adjusted value derived for the optimal item choice and the circumstance adjusted value for the suboptimal items. For example, an optimal boot item has a circumstance adjusted value of 15 credits while a suboptimal belt item has a circumstance adjusted value of 8. In this example, the suboptimality score for the belt item would be (15-8) or 7 credits.

In various embodiments, when a user makes the optimal choice during a transaction, behavior module 113 credits the user’s behavioral profile in one or more elements. When a user makes a sub-optimal choice during a transaction, behavior module 113 penalizes the user’s behavioral profile in one or more elements. Based on the ratio between the suboptimal circumstance adjusted value for the suboptimal item and the circumstance adjusted value for the optimum item, behavior module 113 penalizes the behavioral profile in one or more elements related to the perceive bias or heuristic determined by behavior module 113 to be the motivation in the user making the suboptimal decision.

In various embodiments, behavior module 113 generates and maintains a behavioral profile for each user who utilize game clients 122a-n. The behavioral profile includes multiple elements that correspond to various logical bias and heuristics that humans may occur when making decisions, such as a transaction in a game as discussed herein. Example behavioral profile includes, but are not limited to, anchoring bias, projection bias, diversification bias, representativeness heuristic, and availability heuristic. Anchoring bias reflects the tendency of a user to be influenced by an initial exposure to a number. For example, a user bought an experience point boost to gain a few extra levels early game. In this example, the game has a leveling system that increase exponentially, and the same experience boost has diminishing returns, as the boost only gives a flat amount. A user who continues to buy the boost in this case is still “anchored” to the initial larger boost even though the effects and value of the boost diminish over time. Projection bias is the tendency of people to believe their preferences will remain the same over. For example, a user has a large magic attack stat. Projection bias occurs when the user continuously buys items that boost magic attack even though other player statistics could provide better improvements. Diversification bias is the tendency of people to choose more variety among items selected simultaneously than when choosing sequentially. For example, a user continuously buys items that give boosts to all stats and rarely buys boosts in the same category. Representativeness heuristic is a bias that people presume that something is similar to another item based on the similarity yet ignore any differences the two may have. For example, a user believes that all mace type weapons are good because of an armor debuff the weapons apply in-game. In this example, even though the debuffs may vary in effectiveness across different maces, the user still selects a mace because the user perceives the mace as “representing” armor debuffs. Availability heuristic is a bias that people likely select something similar based on a previous or easily “available” example for recent memory or proximity. For example, a user bought a chest that contains a random item. Due to an unlucky roll, the user did not get anything of value. This memory is always in the user mind and is an “available” example to not buy another chest, even though another purchase may yield better results. The above examples are not meant to be an exhaustive list. One of ordinary skill in the art will appreciate that a large variety of behavioral biases, heuristic and other behavioral indicators may be monitored and evaluated during each transaction without deviating from the invention.

In various embodiments, behavior module 113 credits or penalizes one or more behavioral element of the user’s behavioral profile based on the user making an optimal or suboptimal decision during a transaction. Behavior module 113 identifies each behavioral element that is present in a transaction for suboptimal items offered in the transaction (e.g., a transaction has an optimal choice and two other choices identified to be related to “Representativeness Heuristic” and “Projection Bias”. If the user selects the optimal item, then behavior module 113 credits each of the behavioral element associated with the items the user did not select. If the user selects a suboptimal item, then behavior module 113 penalizes the behavioral element associated with the suboptimal item the user selected. Behavior module 113 credits or penalizes one or more behavioral element based on the ratio between the suboptimal circumstance adjusted value for the suboptimal item and the circumstance adjusted value for the optimum item.

In various embodiments, behavior module 113 monitors changes in the elements of the behavioral profile for each user. If one or more elements of a user’s behavioral profile change above a certain deviation or amount from the expected value for the element, then behavior module 113 determines the account is possibly compromised by another user or has been sold to another user. In many online games, some users create accounts, play the accounts to a certain level, and then sell the account to another user. Typically, this is against the terms of the service of the game and something the game developers actively discouraged to have a fair playing field among all players. Similarly, sharing accounts is also typically against the terms of service for the game as well. An account with multiple users will drastically shift among the behavioral elements as each user’s biases will influence the profile differently. Embodiments of the present invention recognize that by building and monitoring behavioral profiles of users based on the in-game transactions incurred by a user, that behavior module 113 is able to detect changes in user choice which may indicate that the account is sold to another user, who instinctively will have another type of behavioral profile. When behavior module 113 detects that one or more elements of a user’s behavioral profile change above a certain deviation or amount from the expected value for the element, then behavior module 113 disables, deletes or otherwise restricts the account of the user. In some scenarios, behavior module 113 may flag the account for additional review where additional measure to ensure that the account has not been sold or is being shared by multiple people.

In some embodiments, in response to behavior module 113 detecting that an element in the behavioral profile has deviated from the expected value for the element, behavior module 113 sends an indication to game coordinator program 112 that the account may be in use by a different user. In response, game coordinator program 112 generates a “leading” transaction that is designed to test that the identified element that has deviated form the expected value in the flagged user account. The leading transaction leads or otherwise constructs a fabricated transaction that makes the specific bias in question the most suboptimal choice. As used herein a fabricated offer or transaction is a false offer made to the user in order to test in deviances in behavioral profiles, either by the account or across all player accounts. The fabricated offer will include an item in the offer that will reinforce or activate the perceived bias that the fabricated transaction is meant to test. Other items will be offered that do not test the bias to determine if the user is behaving within the user’s behavioral profile (when testing for account sharing or selling) or across the player base or portion thereof (when testing for boosters, farmers or other players who make purchases decisions out of step from the player base).

For example, if a user has been flagged that the “Anchoring Bias” element has deviated beyond a certain threshold for the expected value of the profile that was derived from prior transactions from the account, then behavior module 113 identifies the factor that the user is anchored to (e.g., magic attack items) to see if the user still has the same anchoring bias. If the user selects the item testing the bias (e.g., an item that boosts magic attack), then behavior module 113 determines the account is being operated outside the bias of the player indicating possible a shared or sold account. In response behavior module 113 flags the account for review or disables, deletes or otherwise restricts the account of the user. If the user instead performs the expected action and chooses the item with the anchoring bias, then behavior module 113 credits the account’s behavioral profile element. In some scenarios, the leading question may be an in-game transaction that is generated when the user visits another shop of non-playable character. In another scenario, an artificially created user account enters into a transaction with the suspected user.

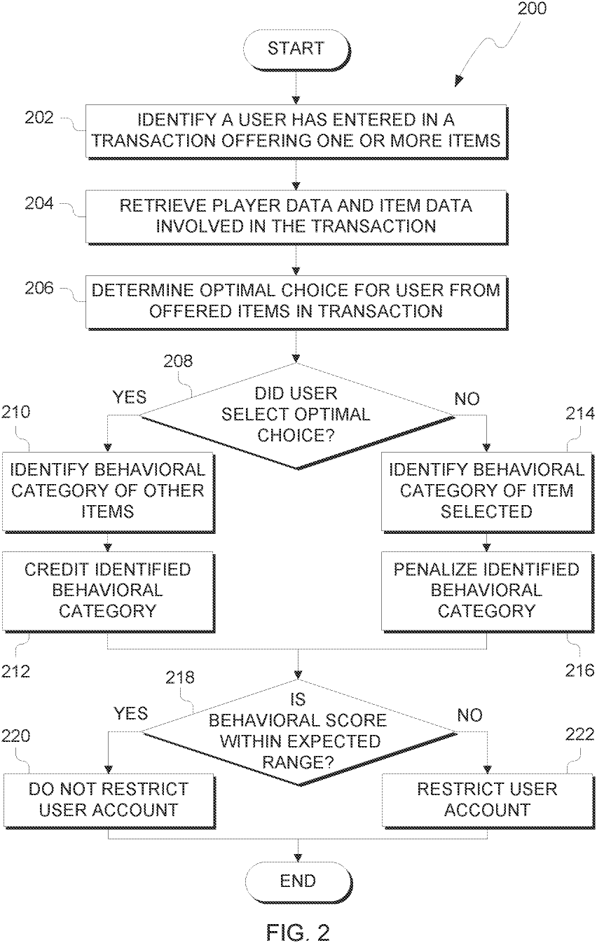

FIG. 2 illustrates operational processes, generally designated 200, of behavior module 113 in game coordinator program 112. In process 202, game coordinator program 112 identifies that a user has entered in a transaction that offers one or more in-game items. In some scenarios, the transaction is between the user and a non-playable character, such as a shopkeep, that offers items for sale to the user within the game world maintained by game coordinator program 112. In other scenarios, the transaction is between two users via their respective in-game characters. In some embodiments, the transaction may occur outside the game world, such as via a website outside the game world. When game coordinator program 112 identifies that a transaction occurs, game coordinator program 112 passes along the player or players involved and the items that were part of the transaction to behavior module 113.

In process 204, behavior module 113 retrieves player data 116 for the user who made the purchase in the transaction and item data 118 for the items offered to the user in the transaction. In some scenarios, the items offered the transaction may include each item offered to the user during the transaction. In scenarios where a large number of items are offered, game coordinator program 112 tracks user input to determine which items the user considered during the transaction. For example, if the user hovered over or viewed an item, then game coordinator program 112 determines the items was considered as being offered during the transaction.

In process 206, behavior module 113 determines the optimal choice for the user among the items offered in the transaction. Based on the current player data 116 at the time of the transaction, behavior module 113 determines the benefit each offered or viewed item provides via the stats, buffs, and other player data 116 altering aspects of the items. Based the determined benefit, behavior module 113 adjust the cost of the item to reflect the increased or decreased value the item provides to the user, generating a circumstance adjusted value that reflects the specific value the player character would get from the item at the time of the transaction. The item with the greatest circumstance adjusted value is considered the optimal choice, while the other items are considered suboptimal based on the amount from the item with the greatest circumstance adjusted value.

In decision process 208, behavior module 113 determines if the user selected the optimal choice. If the user selected the item with the highest circumstance adjusted value determined in process 206 (YES Branch of decision process 208), then the user selected the optimal choice for the transaction. In response, behavior module 113 identifies the behavioral element categories for the other items involved in the transaction (process 210) and credits each category based on a ratio between the circumstance adjusted value for each suboptimal item offered and the circumstance adjusted value for the optimum item selected (process 212). If the user selected any of the other items with smaller circumstance adjusted values determined in process 206 (NO Branch of decision process 208), then the user selected a suboptimal item. In response, behavior module 113 identifies the behavioral element categories for the suboptimal item selected in the transaction (process 214) and the categories based on a ratio between the circumstance adjusted value for the suboptimal item selected and the circumstance adjusted value for the optimum item offered (process 216).

In decision process 218, behavior module 113 evaluates the user’s behavioral profile. In some embodiments or scenarios, behavior module 113 evaluates the user’s behavioral profile after each transaction. In other embodiments, process 218, 220, and 222 may occur after a certain number of transactions are incurred by a user to establish a baseline behavioral profile for more accurate evaluations. In some embodiments, behavior module 113 generates a distribution curve based on the overall userbase’s respective behavioral scores across each bias or element being monitored. For example, based on statistical analysis of the player based, a Gaussian Distribution comprising an expected, or mean, score for each element as well as a variance among the user base. If a user is outside a certain standard deviation in the distribution curve of the overall userbase, then behavior module 113 is outside the expected range (NO branch of decision process 218). In response, behavior module 113 instructs game coordinator program 112 to restrict the user’s account (process 222). While restricted the user may not be able to trade or may have other restrictions placed on the account, up to banning or removing the account from being able to access game coordinator program 112. If the user is within the expected range (YES branch of decision process 218), then behavior module 113 does not restrict the account (process 220). By comparing a user’s behavioral profile to the overall population for the game, embodiments of the present invention can identify user accounts that deviate from normal playstyles, indicating accounts that abuse exploits or other actions that are against a game’s terms of service.

In some embodiments, in order to detect account transfers or multiple players on a single account, process 218 compares one or more recent transactions and determined behavioral scores to a historic user distribution of previous transactions. For example, for the last twenty transactions, the two most recent transactions are compared to a distribution curve derived from the older eighteen transactions. If the scores for the two most recent transactions are outside an expected range of the historic distribution curve for a user (NO branch of decision process 218), then behavior module 113 instructs game coordinator program 112 to restrict the user’s account (process 222). By comparing a profile’s recent behavioral scores to a historic distribution of the profile’s behavioral scores, embodiments of the present invention can identify user accounts that may be operated or shared by more than one person, possibly indicating accounts that abuse terms of service agreements about account sharing and selling.

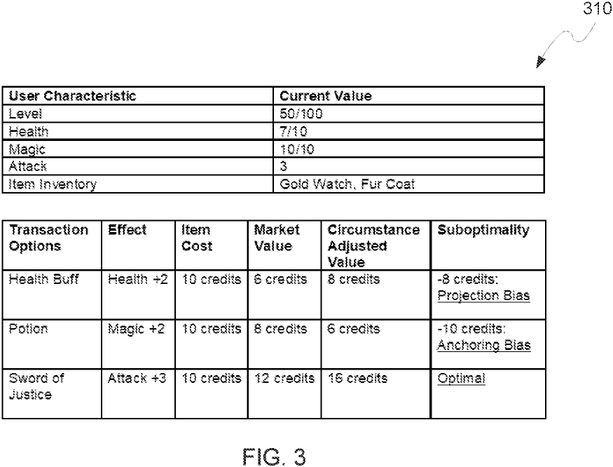

FIG. 3 depicts an example scenario, designated as example 310, with player data 116 and item data 118 involved in a transaction. In example 310, player data 116 for a user at the time of a transaction is presented. At the time of making the transaction, the user’s player character is level 50, with 7 out of 10 hit points of health, a full amount of 10 magic points, a +3 attack rating, and is equipped with a Gold Watch and a Fur Coat. Item data 118 is provided for the three items offered in a transaction, which include a health buff, a potion and the Sword of Justice. Each item has an effect of the player character with the health buff giving +2 hit points, the potion giving +2 mana points and the Sword of Justice giving +3 attack rating. Each item has an item cost and market value. Item cost is the purchase cost of the item if purchased directly from the game world (e.g., from an in-game shop or non-playable character). Market value is the average cost of the item in in-game marketplaces or when two player-controlled characters enter a transaction. In this example, market value will be used, however item cost may also be used when evaluating transactions between a user and non-playable vendors.

As discussed herein, behavior module 113 determines a circumstance adjusted value for each item in the transaction. The circumstance adjusted value adjust the item cost or market value based on the current player’s circumstance based on the current player data 116 at the time of the transaction. Looking at the Potion, the circumstance adjusted value is 6 credits or -2 of the market value. Since the user’s player data 116 indicates a full mana pool, purchasing this item is suboptimal. As for the Health Buff, the player data 116 indicates missing health with 7/10 hit points for the player character. As such, behavior module 113 increases the circumstance adjusted value to 8 credits.

Now, looking at the Sword of Justice, player data 116 indicates a low attack rating of +3, with the Sword of Justice doubling the stat if equipped. Based on this greater marginal improvement to the player data over the Health Buff, behavior module 113 determines a greater adjustment to the circumstance adjusted value, making it 16 credits for the sword. As such, in this example, behavior module 113 determines the sword to be the optimal choice for this particular transaction at the time it occurred. For the remaining suboptimal choices, behavior module 113 determines a behavior profile element that would indicate the bias the user would have if those suboptimal choices were made. For the Health Buff, behavior module 113 determines this suboptimal choice would reflect a projection bias. While the user’s health is not full and provides some benefit, behavior module 113 determines the marginal improvement is low and therefore would represent a projection bias from the user if selected. For the Potion, behavior module 113 determines this suboptimal choice would reflect an anchoring bias. Since the use is at full magic, there is no benefit to the purchase. As such, behavior module 113 determines the potion would reflect an anchoring bias since the repeated purchase of a non-beneficial item would illustrate some bias in acquiring the item.

FIG. 4 depicts a block diagram, 400, of components of game server 110 and user device(s) 120a-n, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Game server 110 and user device(s) 120a-n each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Game coordinator program 112, behavior module 113, player data 116, item data 118 and game client 122 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 130. In these examples, communications unit 410 includes one or more network interface cards. Communications unit 410 may provide communications through the use of either or both physical and wireless communications links. Game coordinator program 112, behavior module 113, player data 116, item data 118 and game client 122 may be downloaded to persistent storage 408 through communications unit 410.

I/O interface(s) 412 allows for input and output of data with other devices that may be connected to Game server 110 or user device(s) 120a-n. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., game coordinator program 112, behavior module 113, player data 116, item data 118 and game client 122, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
identifying, by one or more processors, a transaction involving a player character operated by a user within a game, the transaction including one or more offers of items;
retrieving, by the one or more processors, player data associated with the player character and item data associated with the items offered during the transaction involving the player character;
determining, by the one or more processors, an optimal choice for the player character based on a comparison between the player data and the item data during the transaction;
in response to the user selecting a suboptimal choice different from the optimal choice, adjusting, by the one or more processors, at least one behavioral score of a profile associated with the user; and
in response to the at least one behavioral score being outside an expected range of the at least one behavioral score, restricting, by the one or more processors, at least one aspect of an account associated with the player character.

2. The method of claim 1, wherein the expected range is based on a user base of the game.

3. The method of claim 1, wherein the expected range is based on a group of previous transactions performed by the user.

4. The method of claim 1, the method further comprising:
in response to the at least one behavioral score being outside an expected range of the at least one behavioral score, generating, by the one or more processors, a fabricated transaction with at least one item that tests a category associated with the at least one behavioral score; and
sending, by the one or more processors, an offer of the transaction to the player character.

5. The method of claim 1, the method further comprising:
in response to the player character selecting the at least one item that tests the category associated with the at least one behavioral score, restricting, by the one or more processors, the at least one aspect of an account associated with the player character.

6. The method of claim 1, wherein the at least one behavioral score is associated with one of the following: an anchoring bias of the user, a projection bias of the user, a diversification bias of the user, a representativeness heuristic used by the user, and a availability heuristic used by the user.

7. The method of claim 1, wherein determining the optimal choice for the player character further comprises:
determining, by the one or more processors, a circumstance adjusted value for each item in the transaction, wherein the circumstance adjusted value adjusts a cost of each item based on a marginal improvement each item provides to one or more values of player data.

8. A computer program product comprising:
one or more computer-readable storage media and program instructions stored on the one or more computer-readable storage media, the program instructions comprising:
program instructions to identify a transaction involving a player character operated by a user within a game, the transaction including one or more offers of items;
program instructions to retrieve player data associated with the player character and item data associated with the items offered during the transaction involving the player character;
program instructions to determine an optimal choice for the player character based on a comparison between the player data and the item data during the transaction;
program instructions to, in response to the user selecting a suboptimal choice different from the optimal choice, adjust at least one behavioral score of a profile associated with the user; and
program instructions to, in response to the at least one behavioral score being outside an expected range of the at least one behavioral score, restrict at least one aspect of an account associated with the player character.

9. The computer program product of claim 8, wherein the expected range is based on a user base of the game.

10. The computer program product of claim 8, wherein the expected range is based on a group of previous transactions performed by the user.

11. The computer program product of claim 8, the program instructions further comprising:
program instructions to, in response to the at least one behavioral score being outside an expected range of the at least one behavioral score, generate a fabricated transaction with at least one item that tests a category associated with the at least one behavioral score; and
program instructions to send an offer of the transaction to the player character.

12. The computer program product of claim 11, the method further comprising:
program instructions to, in response to the player character selecting the at least one item that tests the category associated with the at least one behavioral score, restrict the at least one aspect of an account associated with the player character.

13. The computer program product of claim 8, wherein the at least one behavioral score is associated with one of the following: an anchoring bias of the user, a projection bias of the user, a diversification bias of the user, a representativeness heuristic used by the user, and a availability heuristic used by the user.

14. The computer program product of claim 8, wherein program instructions to determine the optimal choice for the player character further comprises:
program instructions to determine a circumstance adjusted value for each item in the transaction, wherein the circumstance adjusted value adjusts a cost of each item based on a marginal improvement each item provides to one or more values of player data.

15. A computer system comprising:
one or more computer processors;
one or more computer readable storage media; and
program instructions stored on the computer readable storage media for execution by at least one of the one or more processors, the program instructions comprising:
program instructions to identify a transaction involving a player character operated by a user within a game, the transaction including one or more offers of items;
program instructions to retrieve player data associated with the player character and item data associated with the items offered during the transaction involving the player character;
program instructions to determine an optimal choice for the player character based on a comparison between the player data and the item data during the transaction;
program instructions to, in response to the user selecting a suboptimal choice different from the optimal choice, adjust at least one behavioral score of a profile associated with the user; and
program instructions to, in response to the at least one behavioral score being outside an expected range of the at least one behavioral score, restrict at least one aspect of an account associated with the player character.

16. The computer system of claim 15, wherein the expected range is based on a user base of the game.

17. The computer system of claim 15, wherein the expected range is based on a group of previous transactions performed by the user.

18. The computer system of claim 15, the program instructions further comprising:
program instructions to, in response to the at least one behavioral score being outside an expected range of the at least one behavioral score, generate a fabricated transaction with at least one item that tests a category associated with the at least one behavioral score; and
program instructions to send an offer of the transaction to the player character.

19. The computer system of claim 18, the method further comprising:
program instructions to, in response to the player character selecting the at least one item that tests the category associated with the at least one behavioral score, restrict the at least one aspect of an account associated with the player character.

20. The computer system of claim 15, wherein the at least one behavioral score is associated with one of the following: an anchoring bias of the user, a projection bias of the user, a diversification bias of the user, a representativeness heuristic used by the user, and a availability heuristic used by the user.
